(19) United States
(12) Patent Application Publication
(10) Pub. No.: US 2010/0014595 A1
(43) Pub. Date: Jan. 21, 2010

(54) AUDIO AND/OR VIDEO DATA PROCESSING DEVICE, COMMUNICATION OR DATA NETWORK FOR TRANSCODING AUDIO AND/OR VIDEO DATA, AND METHOD FOR DECODING AUDIO AND/OR VIDEO DATA

(76) Inventor: Wilfried Platzer, Freiburg (DE)

Correspondence Address: O''Shea Getz P.C., 1500 MAIN ST. SUITE 912, SPRINGFIELD, MA, 01115, US

(21) Appl. No.: 12/489,200

(22) Filed: Jun. 22, 2009

(30) Foreign Application Priority Data
Jun. 20, 2008 (DE) 10 2008 029 102.1

(51) Int. Cl. H04N 7/24

(52) U.S. Cl. 375/240.26; 375/E07.02

(57) ABSTRACT

The invention relates to an audio and/or video data processing device having at least one interface for making available audio and/or video data as coded data (dsi, dso*), and an audio-video decoder (AVD) that decodes the data (dsi, dso) coded with at least one code (k) to produce decoded data (d), and a transcoding interface (IFT) that outputs unsuitably coded data (dso*), which are coded with a code (k*) unsuitable for the audio-video decoder (AVD) to a format conversion module (TC) and for receiving transcoded coded data (dso) transcoded to a code (k) suitable for the audio-video decoder (AVD). Transcoding interface (IFT) is a network interface for communication over the data network (N) for transmitting the unsuitably coded data (dso*) to the format conversion module (TC) and the transcoded coded data (dso) from the format conversion module (TC) via the communication or data network (N).

### PRIORITY INFORMATION

This patent application claims priority from German Patent Application No. 10 2008 029 102.1 filed Jun. 20, 2008, which is hereby incorporated by reference in its entirety.

### BACKGROUND OF THE INVENTION

The invention relates to an audio and/or video data processing device, and in particular to a distributed decode device.

German patent DE 20 2005 003 176 U1 describes a so-called CI module for the conversion of data reduction formats for audio/video signals. Such a module can be plugged into a CI port as a transcoding interface of a data processing device, such as a radio receiver. This allows data processing device to receive and decompress data that has been coded or compressed not only by of MPEG 2, but also to decompress data compressed using MPEG 4. The existence of CI ports on, for example, DVB receivers, which serve for the demodulation of a data stream, is exploited in this case, with the data stream transmitting encrypted data of a pay television provider.

Accordingly known is an audio/video data processing device in the form of a DVB receiver, which, as a medium interface, is linked to an antenna or to a cable television connection for receiving coded data as audio and video data. In addition, this data processing device has an audio/video decoder for decoding data that are coded with a suitable code to produce decoded data. The decoded data can then be output to a television set by an output device. In this case, a transcoding interface serves for plugging in a format conversion module, to which data coded with an unsuitable code are applied and are then decoded or transcoded to suitably coded data in the format conversion module, so as subsequently to be transformed in the usual manner and way to the decoded data in the audio/video decoder of the data processing device.

A drawback of such a data processing device is that, in the case of a new code or of a code that is not known to the data processing device, the decoding of received audio/video data is possible only when a hardware or software update is provided, in the case of an existing transcoding interface, a suitable new decoder is connected. Otherwise, a device without such updated software, hardware, or a proper decoder cannot play back audio and/or video data.

Provided that a corresponding data processing device can be upgraded at all by running appropriate software algorithms, there often exists the additional problem that upgrading with algorithms or codecs is possible to only a limited extent, because, oftentimes, no suitable hardware is available for modern high-performance codecs.

Therefore, there is a need for an improved audio and/or video data processing device.

### SUMMARY OF THE INVENTION

An audio and/or video data processing device includes at least one medium interface, which makes available audio and/or video data as coded data, and an audio-video decoder, that decodes data coded with at least one code suitable for the audio-video decoder to produce decoded data. The data processing device also includes an output device for outputting the data decoded by the audio-video decoder, and a transcoding interface. The transcoding interface provides unsuitably coded data of the coded data, which are coded with a code that is unsuitable for the audio-video decoder, to a format conversion module and for receiving transcoded coded data, which were transcoded in a code that is suitable for the audio-video decoder, and for making available the transcoded coded data for the audio-video decoder. The transcoding interface is preferably designed and/or controlled as a network interface of a communication or data network for transmitting the unsuitably coded data to the format conversion module and for transmitting the transcoded coded data from the format conversion module via the communication or data network.

Rather than a fixed transcoding interface assigned to the data processing device for direct plugging in of a decoder module, a transcoding interface may include appropriate actuation that makes facilitates communication via the network, in particular via a communication or data network. As a result, it is not only possible to access a locally available decoder, but also to access remote decoders, which are available somewhere within the network. For decoding of received data that are coded with an unsupported code (i.e., not decodable by the data processing device), access to the remote decoder is provided.

An remote decoder need not be regarded as a device that is located far removed from the data processing device with the coded data that is unsuitable for it. Contemplated in this case is the use of a conventional communication or data network. Therefore, in the case of a network integrated within the data processing device, a decoding component may also be regarded as an external format conversion module even inside the housing of the data processing device. The format conversion module is accessed via the network and.

Preferably, the transcoding interface or a control device of the data processing device transmits the unsuitably coded data to one of a plurality of such format conversion modules selected by a code-dependent piece of information and designed and/or controlled for transcoding the unsuitably coded data with the at least one code supported by the audio-video decoder. On the basis of the unsuitable code for which it knows a suitable format conversion module, an appropriately designed control device can direct the transcoding interface to access a format conversion module that is suitable for this unsuitable code, so that it is not necessary to access a plurality of format conversion modules, which are each known for various unsuitable codes in the data processing device, until, ultimately, a suitable format conversion module receives transmission of the unsuitably coded data and transmits it back in decoded form. In this case, the code-dependent piece of information is, in particular, the unsuitable code itself and piece of information concerning a suitable format conversion module, which is communicated to the transcoding interface for access to the suitable format conversion module by a control device. The transcoding device itself may also determine such a code-dependent piece of information either itself on the basis of the unsuitably coded data or, after receipt by way of a central control device of the data processing device, it can process the piece of information and/or retransmit the piece of information together with unsuitably coded data.

In this case, the code-dependent piece of information may be, in particular, a network address of the selected format conversion module. The code-dependent information may also be search command information for searching for a suitable format conversion module within the network. Since the code-dependent piece of information to use a network address makes it possible to convey directly the unsuitably coded data to the suitable format conversion module, a fast access to the format conversion module is made possible. Optionally, in a preparatory step, prior to a transmission of the unsuitably coded data, an appropriate reservation of capacities of the format conversion module may also be carried out by the transcoding interface. If the format conversion module capable of processing the unsuitable code is not known, search command information for searching may also be advantageous, because this enables the data processing device to search the network automatically for a suitable conversion module via appropriate search engines or specific independent search routines.

It is generally preferred when the transcoding interface or a control device of the data processing device is designed and/or controlled for transmitting the unsuitably coded data to at least one parser located in the network to enable the parser to determine the unsuitable code. In the case of an unknown code, for which no information about a suitable transcoder that may suitably convert unsuitably coded data with the unsuitable code is available, it is thus possible, in a first step, to determine the unknown unsuitable code so as, in a subsequent step, to select a suitable transcoder for converting the data. In this case, it is contemplated that the device with the parser has, in addition, a suitable transcoder and carries out the conversion to the suitably coded data.

The data processing device is preferably comprises a control device and/or audio-video decoder for determination of the coded data made available by the at least one medium interface, and in the case of the coding with a code that is unsuitable for the audio-video decoder, to output the unsuitably coded data of the coded data via the transcoding interface. That is, when coded data is received, the code used for the coding is searched for by the data processing device to determine whether this code may be decoded by the audio/video decoder. In the case that the audio/video decoder cannot decode this code, the data that are recognized as being unsuitably coded are output via the decoding interface to an external format conversion module. As a result, processing time is saved, because not all received data are automatically sent to the transcoding interface, but instead an attempt is first made to decode the received data in the data processing device itself.

The decoding interface or a control device of the data processing device and of the format conversion module preferably time synchronization the unsuitably coded data and the suitably coded data. It is thereby ensured that, in the case of a delayed transmission of individual data packets in the network, a interchange of the decoded data that is received back is prevented and the time sequence during the decoding and, in particular, the subsequent play-back of the audio and/or video data is ensured in the correct time sequence. The time synchronization can take place, for example, in that, during transmission of unsuitably coded data via the transcoding interface, a packet number is inserted beforehand, on the basis of which, after the back transmission, time synchronization is made possible.

The communication or data network may include an interface that connects the transcoding interface of the audio and/or video data processing device, and at least one interface for connection with the transcoding interface of the format conversion module. In this case, the at least one format conversion module receives the unsuitably coded data, for transcoding of the unsuitably coded data with a code that is suitable for the data processing device, to produce transcoded coded data that are transmitted to the data processing device.

These and other objects, features and advantages of the present invention will become more apparent in light of the following detailed description of preferred embodiments thereof, as illustrated in the accompanying drawings.

### BRIEF DESCRIPTION OF THE DRAWINGS

The FIGURE is a block diagram illustration of an audio/video data processing device that communicates with a format converter via a network.

### DETAILED DESCRIPTION OF THE INVENTION

The FIGURE is a block diagram illustration of an audio/video data processing device TV that communicates with a format converter via a network.

The data processing device TV may include, for example, a television set. However, one of ordinary skill in the art will recognize that the data processing device may include other devices having a decoding function, such as for example, computers, radio sets, television receiving devices, or DVD recorders. The data processing device TV includes an audio/video decoder AVD that comprises one or more interfaces MI1, MI2. Via the one or more interfaces MI1, MI2, AVD-coded data dso*, dsi can be applied to the audio/video decoder AVD, which are decoded by the audio/video decoder AVD and output as decoded data d.

The decoded data d are applied to an audio/video output device AVO, which edits the decoded data d for play back via a display device D and a loudspeaker L. However, it is also possible to provide an interface for transmission to a separate memory storage or play-back device than such an audio/video output device of the data processing device.

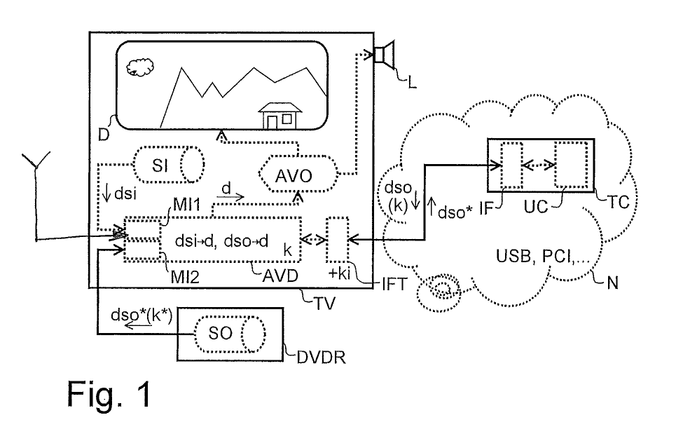

The data processing device may include an internal memory, for example, a hard drive or a DVD player. Coded data are output from the internal memory to interface MI1, the coded data being compatible with the at least one second code k, which can be processed in the audio/video decoder AVD. The data from the internal data source DVDR may be decoded by the audio/video decoder. As FIG. 1 shows, the coded data may also be delivered alternatively or additionally via an antenna, for example, to the medium interface MI1.

The data processing device TV may also communicate with an external memory device, for example, a hard drive or a DVD player. The external memory device provides coded data to the associated interface MI1, these data being incompatible, however, with the at least one second code k, and thus cannot be decoded in the audio/video decoder AVD. The data from the external data source DVDR are correspondingly unsuitably coded data dso* from the perspective of the audio/video decoders AVD.

Therefore, from the audio/video decoder AVD or from an independent control device, in the case that the second interface MI2 is designed, for example, as an independent component, the unsuitably coded data dso* are delivered to the transcoding interface IFT and transmitted by the transcoding interface IFT via the network N to the format conversion module TC.

The format conversion module TC receives the data dso*, which can not be decoded by the audio/video decoder, and transcodes it. The format conversion module TC provides transcoded coded or second coded data dso and over the network N to the transcoding interface IFT of the data processing device TV. The transcoding interface IFT thus serves, from the perspective of the audio/video decoder AVD, as yet another medium interface, via which transcoded coded data dso are applied as data coded with a suitable code k. The audio/video decoder AVD correspondingly provides data it is unable to decode to the format conversion module via the network interface. The format conversion device then provides transcoded data back to the audio/video decoder for further processing. In this case, correspondingly transcoded decoded data dso are made available by the format conversion module TC in such a way that the second code k used from recoding during transcoding is used as a code k that is suitable for the audio/video decoder AVD.

The format conversion module TC communicates with the audio/video decoder via the network (e.g., a packet switched network). The format conversion device receives the coded data over the network from the audio/video decoder and decodes it, and provides transcoded data back to the audio/video decoder via the network. The transcoding interface IF receives first coded data dso* that are coded with the first code k*, and outputs the second coded data dso which were coded with the second code k. The transcoder UC decodes the first coded data dso* and records it with the second code k to produce the second coded data dso. Direct transcoding of the first coded data dso* to produce the second coded data dso may be carried out by the transcoder UC.

The network N may be, for example, the Internet, an intranet, Ethernet or USB (universal serial bus). In principal, however, it is also possible to employ networks N for which a specific transmission control by one of the connected components is performed.

The transcoding interfaces IFT, IF of the data processing device, or the format conversion module TC, are interfaces suitable for the network N being used. These may be designed and configured, or implemented as standard interfaces. In the case of a USB interface as a transcoding interface used, for example, the corresponding devices, in particular the data processing device TV, have a central controller as a control device for managing the USB communication and for controlling the data streams. To these are applied the coded data dso* or dso for transmission to the other respective devices.

Accordingly an audio/video decoder building block is provided that receives an encoded audio/video data stream from a connected medium, for which it does not have its own decoder or does not have a suitable decoding code. Such a decoder is searched for in a connected network N or specifically actuated so as to have decoded there the data dso* that is not suitably coded for the audio/video decoder AVD. Once a conversion of the coded data to a proper standard has been performed by a format conversion module TC of the remote decoder, and the transcoded coded data dso has been transmitted back, the audio/video decoder AVD can then decode and play back this audio/video data stream.

Advantageously, with network accessible format conversion modules TC, any desired audio and/or video data stream can be transcoded, so that the data processing device TV can always also take into account updated codes by accessing suitable format conversion modules TC. Therefore, updating of the software or hardware in the data processing device or a connection of a current module directly to the data processing device is no longer required.

A user audio/video device, such as the exemplary data processing device TV with an integrated decompressing or decoding audio/video decoder AVD can thus access data streams of a wide variety of media that provide coded data. In this case, coded data are understood to also include compressed data. For the case that the audio/video decoder AVD does not support the compression standard, the data processing device can search for a proper transcoder on the network N or, if necessary, directly access a suitable transcoder in a specific manner, which can convert or transcode the data stream to a supported format. To this end, the data stream is transmitted via the network N in the exemplary format conversion module TC, and the transcoded signal is transmitted back to the data processing device, which can then carry out the decoding in the usual manner and way by of its audio/video decoder AVD.

The network N may be established, in particular, also within the data processing device TV or can be created by a standard bus system, which, for example, makes it possible to use the format conversion module TC as a so-called USB dongle with an integrated transcoder as the transcoder UC.

A user of the data processing device selects a desired audio/video data stream, such as, for example the unsuitably coded data dso* from the external data source DVDR for playing on the data processing device. The coded data dso*, dsi may, in this case, be selected from various internal or external media. The media may include for example, radio, a USB memory device connected to a USB port, or an external memory storage medium such as DVD, Blueray, HD, DVD, or CD standards.

The audio/video decoder AVD or a subordinate control device checks the header of the data stream of the coded data dso*, dsi, dso to determine if the data can be decoded with the audio/video decoder AVD and played back. Corresponding code-dependent information ki relating to the used code k, k* is available in data containers for various known standards, such as, for example, for standards or software algorithms under the designation, for example, QuickTime, AVI, or Transport Stream.

If the coded data dsi, dso, can be processed by the audio/video decoder AVD, they are directly decoded and output as decoded data d for further processing.

If this is not possible and/or if the unsuitable code k* cannot be determined, the data processing device TV or its transcoding interface IFT or a control device subordinate to it searches in the connected network N for an available format conversion module TC that is capable of transcoding the unsuitably coded data dso* to suitably coded data dso. Provided that, in the ideal case, the data processing device TV has not been already logged-on in the network N to this end, it logs-on itself on the network N, for which purpose, for example, a suitable protocol, such as that for the known protocols UPNP, Zeroconfig, Rendevous, or PNP, can be used. Accordingly, suitable services can be found in the network N and, once they are found, logging-on to such services can be carried out. Subsequently, the unsuitably coded data dso* are then transmitted via the service to the appropriate format conversion module TC for transcoding and for transmission back.

In the case that, through the components and/or algorithms in the data processing device TV, it is not possible to find out with which unsuitable code k* the unsuitably coded data dso* are coded, the unsuitably coded data dso* can be transmitted, in a first step, also to a parser or to a container parser. A parser is preferably arranged in the network N as an additional component or constituent part of an appropriately designed format conversion module TC.

What is involved in the case of such a parser is a component and/or an algorithm with which the received data dso* can be examined for a code k* that is used for coding. Once the code k* is determined, the code is delivered back to the data processing device TV, so that the latter can search for a suitable format conversion module TC, in which the unsuitably coded data dso* can then be transcoded. Alternatively, it is also possible for the component in which the parser is incorporated to perform an appropriate transcoding in a transcoder or to forward the unsuitably coded data dso* to such a transcoder in order to have a transcoding performed. The data dso transcoded in this way is then transmitted back to the data processing device TV.

Suitable networks for carrying out such a method are both internal and also external networks. By way of example, it is possible to employ networks such as wired or wireless Ethernet, a universal serial bus (USB), a PCI bus, or similar plug-and-play-equipped networks according to MOST (media oriented systems transport).

If a suitable transcoder exists in a format conversion module TC, the data processing device TV attempts to carry out a corresponding log-on and certification in order to have a transcoding subsequently performed. Provided that a parser is present, it is also correspondingly reserved as needed and subsequently employed for the determination of a used code.

Once a reservation has taken place, the data processing device TV begins to send the data stream of the unsuitably coded data dso* correspondingly via the network N to the transcoder or the parser. The transcoder or the parser sends back, after the transcoding or parsing, a corresponding data stream. If a parsed data stream contains audio/video formats that are unknown by the parser, a transcoding is appropriately performed. Subsequently, the data processing device TV can begin its decoding and play-back of the received transcoded coded data dso.

The transcoding for audio data and video data may be carried out at several separate transcoders. In the case that audio and video data streams are processed separately, attention is to be paid to a correct synchronization so as to make possible the time-synchronous play-back of sound and image data. A synchronization is also appropriate in order, in the case of transmission via the network N, to sort out once again, if necessary, data packets received with delay into the correct time sequence so as to enable a play-back that is correct in time.

The data processing device TV may also be equipped with its own parser and/or transcoder and then make it available in an internal or else external network N for other data processing devices. In such a case, the data processing device TV is then recognized and used, from the perspective of the external further data processing devices, as a format conversion module.

Although the present invention has been illustrated and described with respect to several preferred embodiments thereof, various changes, omissions and additions to the form and detail thereof, may be made therein, without departing from the spirit and scope of the invention.

What is claimed is:

1. An audio and/or video data processing device, comprising:
at least one medium interface (MI1, MI2) for making available audio and/or video data as coded data (dsi, dso*);
an audio-video decoder (AVD) that decodes data (dsi, dso) that is coded with at least one code (k) suitable for the audio-video decoder (AVD) to produce decoded data (d);
an output device (AVO, D, L) for outputting the decoded data (d) decoded by the audio-video decoder (AVD); and
a transcoding interface (IFT), that outputs unsuitably coded data of the coded data (dso*), which are coded with a code (k*) that is unsuitable for the audio-video decoder (AVD), to a format conversion module (TC) and for receiving transcoded coded data (dso), which were transcoded to a code (k) that is suitable for the audio-video decoder (AVD), and for making available the transcoded coded data (dso) for the audio-video decoder (AVD),
wherein the transcoding interface (IFT) comprises a network interface of a communication or data network (N) for transmitting the unsuitably coded data (dso*) to the format conversion module (TC) and the transcoded coded data (dso) from the format conversion module (TC) via the communication or data network (N).

2. The data processing device of claim 1, wherein the transcoding interface (IFT) transmits the unsuitably coded data (dso*) to a format conversion module (TC) selected from a plurality of such format conversion modules by code-dependent information (ki), the format conversion module transcodes the unsuitably coded data (dso*) with the at least one code (k) that is suitable for the audio-video decoder (AVD).

3. The data processing device of claim 2, wherein the code-dependent information (ki) comprises a network address of the selected format conversion module (TC).

4. The data processing device of claim 3, wherein the code-dependent information (ki) comprises search command information for searching for a suitable format conversion module (TC) within the network (N).

5. The data processing device of claim 2, wherein the transcoding interface (IFT) transmits the unsuitably coded data (dso*) to at least one parser located in the network to allow the parser to determine the unsuitable code (k*).

6. The data processing device of claim 2, wherein the data processing device (TV) is designed and/or controlled by means of a control device and/or the audio-video decoder (AVD) for determining a code of the coded data (dsi, dso*) made available by the at least one medium interface (MI1, MI2) and is designed and/or controlled, in the case of receiving coded data with such a code (k*) that is unsuitable for the audio-video decoder (AVD) to output the unsuitably coded data of the coded data (dso*) via the transcoding interface (IFT).

7. The data processing device of claim 2, wherein the transcoding of the data processing device (TV) and of the format conversion module (TC) are configured and arranged for time synchronization of the unsuitably coded data (dso*) and of the suitably coded data (dso).

8. A method for decoding audio and/or video data as data (dsi, dso) coded with a code (k) that is suitable for the decoding to produce decoded data (d), comprises:
transmitting unsuitably coded data (dso*), which are coded with a code (k*) that is unsuitable for the to a format conversion module (TC);
receiving from the format conversion device coded data (dso), which were transcoded to the at least one suitable code (k), are received via the interface from the unsuitably coded data (dso*); and
decoding the received transcoded coded data (dso);
wherein the unsuitably coded data (dso*) are transmitted to the format conversion module (TC) and the transcoded coded data (dso) are transmitted from the format conversion module (TC) via a communication or data network (N).

9. The method of claim 8, further comprising checking whether the coded data (dsi) that are present can be decoded by a data processing device (TV) that performs the method or by a component that is connected directly to it and, only if this is not the case, such unsuitably coded data (dso*) are transmitted to the format conversion module (TC).

10. The method of claim 8, for which, in the case of an unknown unsuitable code (k*), the unsuitably coded data (dso*) are transmitted via the communication or data network (N) to a parser (10) for determining the unsuitable code (k*).

11. The method of claim 8, for which, in the case of an unknown address of the format conversion module (TC) and/or in the case of an unknown address of a parser, a search is conducted, by an automated search process in the communication or data network (N) for converting the unsuitably coded data (dso*) for a format conversion module (TC) and/or the parser that is suitable for the unsuitable code (k*).

12. The method of claim 8, for which the unsuitably coded data (dso*) and the suitably coded data (dso) are transmitted in a time-synchronized manner or, after a transmission, are once again time-synchronized.
